(19) United States
(12) Patent Application Publication
(10) Pub. No.: US 2025/0288924 A1
(43) Pub. Date: Sep. 18, 2025

(54) METHOD AND APPARATUS FOR DENSIFICATION OF ACTIVATED SLUDGE

(71) Applicant: Terence K. Reid, Poplar Grove, IL (US)

(72) Inventor: Terence K. Reid, Poplar Grove, IL (US)

(73) Assignee: Aqua-Aerobic Systems, Inc., Loves Park, IL (US)

(21) Appl. No.: 18/604,965

(22) Filed: Mar. 14, 2024

(51) Int. Cl. B01D 21/24; C02F 3/28

(52) U.S. Cl. CPC B01D 21/2472; C02F 3/282; C02F 2203/006

(57) ABSTRACT

A method and apparatus for treating wastewater using a sequencing batch reactor wherein the biological solids are densified through hydraulic and organic selection pressures. Wastewater is introduced to the reactor near the end of the treatment cycle under anaerobic conditions following the effluent withdrawal step and prior to the start of next treatment cycle. A floating sludge withdrawal apparatus is used in conjunction with a floating surface mixer to selectively remove lighter flocculant solids and retain denser solids by temporarily reducing the mixing energy during the wasting process.

### FIELD OF THE INVENTION

The present inventions relate to biological treatment of wastewater containing organic matter and nutrients. More specifically, the present inventions provide techniques to modify a sequencing batch reactor activated sludge process to develop a denser biological solids mass that, among other things, improves sedimentation rates and offers more treatment capacity per unit volume.

### BACKGROUND OF THE INVENTION

The activated sludge process has been among the most widely used techniques for treating wastewater sewage since it was developed by Edward Arden and William Lockett over 100 years ago. The process cultivates a diverse population of bacteria, protozoa and microscopic animals to facilitate organic reduction and removal of various forms of nitrogen and phosphorus. Control of the biological environment often includes managing anaerobic, anoxic and aerobic conditions to target specific contaminants or to shift the bacterial population towards beneficial organisms and away from those which impair settling, impede performance efficiency or cause other operational issues. The aeration, anoxic and anaerobic reactions can take place in dedicated tanks, or within the same tank but at different times during the day. Many derivations of the technology exist, but most rely on gravity settling to separate the bacteria from the treated water prior to discharge.

A system's ability to settle is commonly gauged by use of a settled sludge volume (SSV) measurement which is determined by recording the settled volume occupied by the sludge in a one liter cylinder after a specific time period. A typical sludge will settle to about 200 to 400 milliliters (mL) in a one liter container after a 30-minute period. This settling rate will depend on the mass of solids that exists in the system and the SSV is typically measured in milliliters of settled sludge per liter of liquid volume (mL/L). A common value for activated sludge plants that rely on gravity sedimentation is 2 to 4 grams of mixed liquor suspended solids (MLSS) per liter (L) of reactor volume. While maintaining a higher MLSS concentration such as 5 or 6 g/L may offer more treatment capacity, it is usually not feasible due to settling limitations. A metric used to gauge both the settling rate and the solids mass is the sludge volume index (SVI). The SVI is used to characterize the sludge quality by determining the sludge volume (in mL) occupied by 1 gram of activated sludge after 30 minutes of settling. As an example, a well operated activated sludge plant that observes an SSV of 300 mL/L and maintains 3 g/L MLSS will operate successfully with an SVI of 100 mL/g. In fact, a typical 30-minute SVI expected for normal activated sludge will range between 100 and 200 mL/g.

It is common for treatment plants to encounter settling issues due to factors such as influent wastewater quality or quantity conditions, equipment issues or improper operational parameters. In the case of poor settling, an operator may observe an SVI of 250 mL/g with a 3 g/L MLSS. In this case, the operator would have noted that the sludge settled only to 750 mL in a 1-liter container. More importantly, they may also be noting that the sludge blanket level in their clarifier is getting close to the effluent weir or that their effluent quality has higher suspended solids than allowed by permit. The sludge settleability characteristics have been a key operational parameter for the entirety of the activated sludge process' use.

Recent interest has grown in the area of sludge densification. By increasing the specific gravity of the MLSS, the sludge will settle faster and to a higher settled concentration with a 60 to 80 mL/g 30-minute SVI as a common target. An extreme example of sludge densification is the Nereda® Process which is a technology that was invented at the Delft University of Technology and developed commercially by Royal Haskoning DHV. This technology uses a sequencing batch reactor (SBR) configuration to facilitate specific process conditions that promotes the development of activated sludge into densely packed, spherical structures that settle rapidly. The formed granules can be described as microbial-based aggregates that form in a layered, granular morphology without the addition of separate ballast materials and do not coagulate under reduced hydrodynamic shear. The granules formed entirely within the process can range from 0.2 mm to over 4.0 mm and possess settling velocities that are 8 to 10 times faster than conventional activated sludge. Termed aerobic granular sludge (AGS), this process modification results in a biomass where the granules represent more than 70 to 80 percent of the total mass in the system with the remainder comprising a mix of dense to light flocculant sludge. The densely packed granules exhibit SVI's of 30 to 60 mL/g at MLSS levels as high as 8 to 10 g/L. As a result, the Nereda variation of activated sludge does in fact permit MLSS concentrations of 2 to 3 times higher than conventional activated sludge while exhibiting faster and more consistent settling properties. Presently, the Nereda process represents the only full scale AGS technology with installation experience. With over 100 plants under design, in construction or operating, the Nereda process is among the most rapidly growing wastewater treatment technologies. However, it may not be an ideal fit for every plant. In fact, many existing facilities are looking for simply an incremental improvement in their existing settling or treatment capacities rather than the 2 to 3 times improvement offered with the Nereda technology.

There has been significant interest in densification approaches which offer a modest benefit to existing treatment facilities by improving their system's settling properties. Such technologies may improve a wastewater treatment plant's SVI by 20 to 40 percent while permitting a similar increase in MLSS concentrations. One common technique for densifying MLSS is to selectively waste the lighter, less dense flocculant sludge while retaining the faster settling, denser flocculant sludge. For example, selective wasting approaches may reduce a plant's SVI from 100 to 60 mL/g while increasing their MLSS from 3 or 4 g/L to 5 g/L or higher. In some systems which also employ biological nutrient removal, this selective wasting technique may actually promote the formation of small granules that can exceed 0.2 mm but represent only a small fraction of the total biomass. Although it may not reach the augmented biomass characteristics displayed by the Nereda process, the process, mechanical and electrical adaptations may be sufficient to achieve the WWTP's performance needs. Selective wasting can be achieved through various gravimetric devices such as hydrocyclones, phase separators, elevated sludge withdrawal pipes and high rate settling basins.

Selective wasting of the lighter flocculant sludge can increase the overall density of the activated sludge MLSS, but will not cause the formation of aerobic granular sludge. Granule development requires a complex and specific set of process conditions and selective wasting is but one contributing mechanism. Another important mechanism includes developing a feast-famine organic loading condition, with the feast period reflecting a high food-to-mass (F/M) relationship followed by a subsequent famine period with a low F/M. Further, the high F/M period is typically arranged under anaerobic conditions where the dissolved oxygen (DO) is absent and oxidized forms of nitrogen such as nitrates (NO3) and nitrites (NO2) are low. The anaerobic state and high F/M selectively favor the development of slower growing biofilms which are important to creating the granular structure. Certain bacteria are able to break down more complex influent substrates under anaerobic conditions. Without free DO as an electron acceptor, bacteria will use fermentation as alternative metabolic pathway to derive energy from carbohydrates through the action of enzymes. As a result of fermentation, easily degradable organics such as acetic acid, propionic acid and butyric acid are produced. Collectively, these sludge fermentation products are called volatile fatty acids (VFAs). The organisms responsible for creating denser biomass, such a phosphate accumulating organisms (PAOs) or glycogen accumulating organisms (GAOs), grow slow and are less competitive in breaking down readily biodegradable organics in aerobic environments. The availability of VFAs under anaerobic conditions allows the PAOs and GAOs to convert the readily biodegradable organics to slowly degradable storage polymers. In doing so, phosphate is liberated resulting in higher reactor concentrations. However, following the anaerobic time with aerobic treatment allows the PAOs and GAOs to synthesize the stored products in the higher energy environment where oxygen is available to act as the final electron acceptor. As a result, phosphate is taken up at a high rate by the PAOs resulting in enhanced biological phosphorus removal. In addition, the enzymatic reactions which occur in the feast-anaerobic and famine-aerobic sequencing release specific extracellular polymeric substances (EPS) which aid in the development of denser biomass. As such, the development of an anaerobically feed reactor, coupled with selective wasting, is important to developing dense biological solids. Similarly, this coupling will not necessarily develop a fully granular sludge, although the presence of some granules is possible.

There currently exists a variety of related approaches to densify activated sludge. Moving bed biological reactors (MBBR's) use synthetic or natural ballast material to support biofilm growth and increase the overall biomass level in the existing activated sludge system. Membrane biological reactors (MBRs) use microfiltration or ultrafiltration membranes to reject biological solids and discharge particle-free effluent. While MBR's offer the ability to carry MLSS levels as high as 8 to 10 g/L without the need for gravity settling, the membranes require additional tanks, energy and operation and maintenance. Membrane aerated biofilm reactors (MABRs) use membranes to deliver oxygen to biofilms to augment reactor capacity, but rely on separate solid separation devices.

The SBR process has been one of the most successful activated sludge derivatives due to the ability to achieve biological treatment, sedimentation and clarification in a single unit process. Further, proper design of the equipment, tankage and controls will permit time-managed operation of anaerobic, anoxic and aerobic phases to promote biological nutrient removal (BNR). The SBR process can be designed in a single tank, but is most commonly divided into two, three, four or more smaller tanks. By using multiple reactors, the SBR system can treat flow continuously while offering batch processing within individual reactors. With the ability to achieve all process objectives in a single tank, the SBR configuration provides among the highest capacity per unit area of all activated sludge processes. An example of a preferred SBR is the AquaSBR® which was first introduced to the wastewater market in 1986 by Aqua-Aerobic Systems, Inc. and featured independent mixing and aeration to support anaerobic, anoxic and aerobic treatment. Today, the SBR technology has been deployed in thousands of WWTPs and continues to rank among the most common technologies selected due to its ability to effectively achieve total nitrogen levels as low as 3 mg/L and biological phosphorus levels below 1 mg/L. Some SBR systems operate a pseudo batch process where influent is received during the settling and decanting steps. For true batch SBR systems that interrupt flow during the settling and decanting phases, the process can support slightly higher MLSS levels than conventional activated sludge systems. Despite this advantage, the SBR process stands to benefit from densification methods and systems to improve SVIs and further augment MLSS concentrations. The present inventions adapt known physical and biological selection mechanisms to a true batch SBR system to promote the development of a dense biomass to improve settling and increase MLSS levels to increase the treatment capacity per unit area.

### SUMMARY OF THE INVENTION

The present inventions preserve the advantages of known sequencing batch reactor systems and methods and also provide new features and advantages.

The present inventions provide a method and apparatus to increase the density of biological solids in sequencing batch reactor (SBR) wastewater treatment systems through physical and biological selection mechanisms in order to improve biological solids sedimentation and reaction rates. The present inventions restructure the treatment cycle to promote the feast (high F/M) condition in an anaerobic environment followed by a subsequent famine (low F/M) in an aerobic environment to favor PAO growth and promote a denser biological mass. The present inventions also provide a method to selectively remove or waste the slower settling biomass while retaining the faster settling, denser material.

The present inventions provide for a floating sludge collection manifold in conjunction with a floating downflow mixer assembly for use in densifying sludge in a tank or a reactor. The system includes a downflow mixer assembly mounted to an annular float, the mixer assembly including a downwardly projecting discharge volute, the upper end of which includes a fluid intake and the lower end of which includes a propeller and an exit. Also included is a mixer assembly frame attached to an upper side of the annular float and a plurality of manifold support brackets having an upper end attached to the mixer assembly frame and a lower end projecting downward. Solids manifolds are attached to the lower end of the manifold support brackets around the circumference of the annular float, the solids manifold including a plurality of apertures. A plurality of suction hoses are attached to and in fluid communication with the solids manifolds and a source of suction is in communication with the suction hoses wherein suction is applied to the suction hoses to remove less dense flocculant sludge through the solids manifolds, the suction hoses and then out of the reactor.

It will be understood by those of skill in the art that a float, separate from the mixer float, may be provided for the floating sludge collecting manifold assembly. In such an alternative embodiment, the solids manifold would be secured to the float in a manner similar to that in the shared float situation. The method of light flocculant sludge removal or wasting would apply. In yet another alternative embodiment, the sludge collecting manifold assembly may be molded into the float structure.

The present inventions also provide a method for the treatment of wastewater and the densification of sludge in a sequencing batch reactor including the steps of feeding influent substrate into a reactor and which is in contact with sludge particles containing microorganisms. Providing oxygen to the sludge particles and mixing the reactor contents to distribute the liquid and sludge substrate materials is also provided. Permitting the heavier sludge to settle to a lower portion of the reactor and decanting the upper portion of the fluid for discharging treated effluent is also provided.

A preferred method also includes conducting a first anaerobic feed where influent substrate contacts settled sludge particulates; conducting a second anaerobically mixed phase to further reduce substrate; conducting a third aerated reaction phase where oxygen is delivered to the sludge particles in a fluidized state; removing the slow settling sludge particles from the reactor at some point during the third aerated reaction phase using a sludge collecting manifold and a reduced mixing energy; conducting a fourth phase where densified sludge particles settle under quiescent conditions creating an upper zone of treated water; conducting a fifth phase where the clarified and treated water is decanted and discharged without introduction of influent substrate; and, conducting a sixth phase where a second anaerobic feed step delivers influent substrate to settled sludge particles. This effectively removes the lighter flocculant solids while leaving the denser sludge to be retained in the bottom portion of the reactor.

An apparatus of the present invention includes a floating sludge collection manifold assembly that is used in combination with a mixing device to selectively waste lighter biological solids. The invention exploits the mixing flow pattern of a typical floating, high-speed axial downflow mixer which generates a high velocity jet directed to the reactor (basin) floor and subsequently creates a flow vector towards the reactor wall. The mixing flow is redirected vertically upward upon impacting the wall until it reaches the reactor surface where it is further redirected back towards the mixing device to be remixed. With sufficient energy, the floating mixer achieves biological solids uniformity of both light and heavy solids throughout the basin. In a preferred method, the mixing energy is reduced temporarily in the aerated reaction phase to allow the heavy, denser solids to settle while maintaining sufficient energy to suspend the lighter, flocculant solids. During this low energy condition, the floating sludge collection manifold assembly will remove the lighter solids from the basin while leaving the denser solids in the reactor. The mixing energy is then increased upon completion of the solids wasting event to regain uniformity of the remaining denser solids within the reactor and promote improved treatment reactions. A preferred apparatus according to the invention is a major improvement over the prior art due to its ability to float with the variable water depth in an SBR to provide consistent and predictable solids removal characteristics to simplify operations. The preferred method further permits both time and energy adjustments to allow operational optimization to produce the desired biomass consistency. The improvement eliminates the need to distribute a network of sludge collection pipes throughout the basin in order to collect the lighter, slower settling material. Instead, the flow pattern imparted by the floating mixer results in the delivery of this lighter material to a centrally located sludge collection manifold assembly.

A preferred method according to the present invention senses the relative hydraulic loading rate and compares it to maximum design conditions to optimize the cycle structure by increasing substrate availability to anaerobic treatment phases when actual flow rates are below their peak design. Properly designed SBR systems include effluent decant systems which are sized to discharge the treated water over a maximum decant time at peak flow conditions. Often, actual flows are lower than peak design and the time needed to discharge effluent will be less than the programmed decant phase time resulting in a complementary idle phase that is equivalent to this time difference. The optional idle phase can be important in keeping the total cycle time equivalent among multiple reactors to ensure proper treatment occurs in each reactor. Although the idle phase is beneficial in allowing SBR systems to positively address peak flow conditions, many SBR systems are designed to advance to the next cycle when the decanting reactor reaches the low operating water level and do not include an idle phase. Further, many of these systems are not designed with sufficient reactor depth to maintain the desired cycle time when flows exceed average conditions. Hence, those systems which are not designed to treat peak flows without shortening the treatment cycle time cannot benefit from the utility of modifying the idle phase to achieve a process benefit. The present invention permits influent substrate contained in the wastewater flow to be introduced to the reactor during idle phases to promote the effective anaerobic feed conditions necessary for forming denser microbial biomes. An influent distribution system is used to deliver the substrate to the denser biomass to create a feast (high F/M) condition without mixing or aeration of the reactor. The method according to the invention is an improvement over prior art as it increases substrate availability during anaerobic treatment under most conditions, but retains the full cycle time to address unexpected peak flow conditions.

Accordingly, it is an object of the present invention to provide a system and method for densifying sludge in a sequencing batch reactor.

It is another object of the present invention to include a floating downflow mixer assembly and an associated floating sludge collecting manifold assembly to remove the lighter, slower settling solids while leaving the dense solids in the reactor.

It is a further object of the present invention to provide a method of permitting denser solids to settle and remain in the reactor and removing the lighter, flocculant sludge.

It is an additional object of the present invention to provide a method for the densification of sludge in a sequencing batch reactor by feeding substrate into the reactor, providing oxygen to the contents, mixing the contents, permitting the heavier sludge to settle and decanting the upper portion of the fluid for discharge.

It is still another object of the present invention to provide a floating sludge collecting manifold that removes lighter sludge with suction.

It is yet an additional object of the present invention to provide a method that temporarily reduces mixing to allow denser sludge to settle while maintaining sufficient energy to suspend the lighter flocculant solids for removal.

Still yet another object of the present invention is to eliminate the need for a network of sludge collection pipes throughout the reactor basin to collect the lighter, slower settling sludge.

### INVENTOR'S DEFINITION OF THE TERMS

The following terms which may be used in the various claims and/or specification of this patent are intended to have their broadest meaning consistent with the requirements of law:
Settled Sludge Volume means the measurement that is determined by recording the volume occupied by sludge in milliliters in a one liter cylinder after a specified time period. A typical time period is 30 minutes.
Mixed Liquor Suspended Solids means the concentration of suspended solids in an aeration tank in the activated sludge process during the treatment of wastewater. A common value for typical activated sludge plants relying upon gravity sedimentation is 2-4 grams of Mixed Liquor Suspended Solids per liter (g/1) of reactor volume.
Mixed Liquor Volatile Suspended Solids means the biologically active portion of the MLSS which is the concentration of suspended solids in an aeration tank in the activated sludge process during the treatment of wastewater. The MLVSS concentration is normally about 75% of the MLSS concentration.
Sludge Volume Index means a metric used to measure the settling characteristics of activated sludge. It equates to the volume (in mL) occupied by 1 gram of activated sludge after a specified time period. Time periods from 5 to 60 minutes are commonly used, with shorter time periods used for denser sludge and longer periods for slower settling, flocculant sludge.

Where alternative meanings are possible, in either the specification or claims, the broadest meaning is intended consistent with the understanding of those of ordinary skill in the art. All words used in the claims are intended to be used in the normal, customary usage of grammar, the trade and the English language.

### BRIEF DESCRIPTION OF THE DRAWINGS

The stated and unstated objects, features and advantages of the present inventions (sometimes used in the singular, but not excluding the plural) will become apparent from the following descriptions and drawings, wherein like reference numerals represent like elements in the various views, and in which:

FIG. 1 is a graphical representation of a typical SBR cycle structure showing the water level expected at maximum daily flow conditions without an idle phase;

FIG. 2 is a graphical representation of a typical SBR cycle structure showing the water level change expected at average daily flow conditions and includes a non-filling idle phase;

FIG. 3 is a graphical representation of modifications to the SBR cycle structure showing the promotion of sludge densification of the present invention by replacing the non-filling idle phase with an anaerobic feed phase.

FIG. 4 is a cross-sectional view of a typical floating downflow mixer in a basin showing a flow pattern generated by the mixer and also showing a typical influent distribution system and oxygenator structure;

FIG. 5 is a representation of a floating downflow mixer including a sludge collecting manifold assembly of the present invention;

FIG. 6 is a top plan view of a floating downflow mixer and a preferred embodiment of a sludge collecting manifold assembly of the present invention;

FIG. 7 is a side perspective view of the floating mixer and sludge collecting manifold assembly of the present invention;

FIG. 8 is another side perspective view of the floating mixer and sludge collecting manifold assembly of FIG. 7;

FIG. 9 is a perspective view of an alternative embodiment of the present invention wherein the sludge collecting manifold assembly is molded into the float structure.

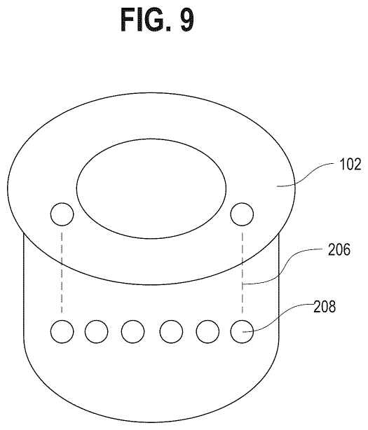

### DETAILED DESCRIPTION OF PREFERRED EMBODIMENTS

Set forth below is a description of what is currently believed to be the preferred embodiments or best representative examples of the inventions claimed. Future and present alternatives and modifications to the embodiments and preferred embodiments are contemplated. Any alternatives or modifications which make insubstantial changes in function, purpose, structure or result are intended to be covered by the claims of this patent.

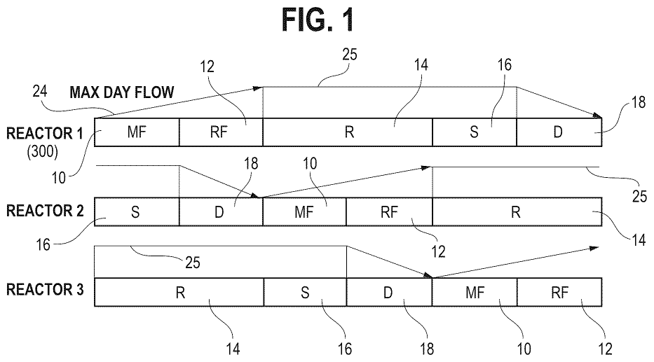

The systems and methods of the present inventions will be described with respect to a typical SBR having three reactors (basins). A typical cycle structure that may be expected for peak design flow (“PDF”) or maximum daily flow or, for present purposes, high water level 25 is shown in FIG. 1.

As shown in FIG. 1, Reactor 1 300 begins its treatment cycle at its low water level (LWL) 24 beginning with the Mix Fill (MF) phase 10. Influent wastewater is introduced to Reactor 1 300 at the beginning of the MF phase 10 and continues until the end of the React Fill (RF) phase 12 where the reactor depth is at its high water level (HWL) 25 or maximum daily flow. As will be understood by those of skill in the art, using valves, the influent flow is then diverted to Reactor 2, which is beginning its MF phase 10. This allows Reactor 1 to enter into a prolonged React phase (R) 14 without flow entering the basin. Reactor 1 then proceeds to the Settle phase(S) 16 to allow the biological solids to settle to the bottom 30 to 40 percent of the reactor 300 depth. The upper 60 to 70 percent of the liquid volume contains high quality, treated water that is ready for discharge. At the end of the Settle phase (S) 16, as will be understood by those of skill, a mechanical decanter opens and lowers the water level in a Decant phase (D) 18 to its original low water level (LWL) 24 operating condition. In a classic SBR, the excess biological solids are wasted from the bottom of the tank for a few minutes near the end of the cycle. The cycle then repeats this operation from one to eight times per day for each reactor. The number of cycles per day depends on the influent waste strength and the effluent objectives.

This example shows three basins that use the same cycle structure, but are temporally offset by ⅓ of the total cycle time. By offsetting the cycles, the flow can be received continuously and in some cases, discharged continuously from the system. SBR systems can be operated in any number of reactors, but are most commonly arranged in two, three or four basin arrangements. The cycle offset is typically set to 1/n of the total cycle time where n equates to the number of basins.

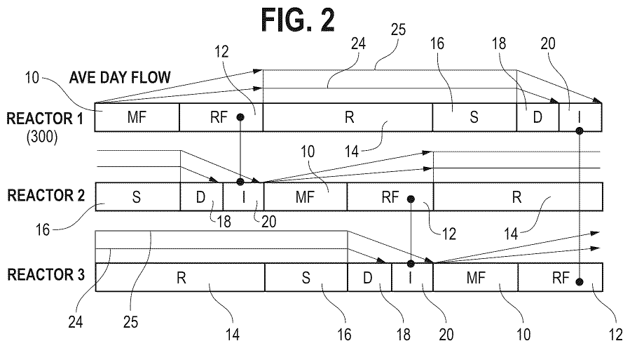

FIG. 2 shows the same cycle structure, but with the addition of average design flow level (ADF) or, for present purposes, low water level 24 conditions which usually combine with the Maximum Month Average Design Flow. In this case, the cycle duration and phase times are exactly the same as during the PDF 25 conditions, but the reactor depth doesn't reach the HWL by the end of the RF phase. As a result, the start of the Decant phase (D) 18 is at a lower depth than during PDF and therefore reaches the LWL 24 in less time than required. Rather than terminating the cycle early, the reactor enters into an Idle phase (I) 20 to allow its companion reactor to finish filling. As such, the Idle (I) phase 20 is just an extension of the Decant phase (D) 18 as needed to maintain a fixed cycle time.

The optional Idle phase (I) 20 exists with a settled solids bed in a quiescent environment that has been preconditioned by nutrient removal and up to two hours of settled and static conditions. It is well known that the bacteria will continue to respire with typical endogenous respiration rates of 4-8 mg of dissolved oxygen (DO) per g mixed liquor volatile suspended solids (MLVSS) per hour, where the MLVSS refers to the organic or volatile portion of the MLSS. The previously treated and settled biomass contains typically 4-7 g MLVSS/L, and would exhibit an oxygen uptake rate (OUR) of about 30-40 mg DO/L/hour (0.5 to 0.7 mg/L/minute) within the sludge blanket at the bottom of the reactor. At the end of aeration and prior to settle, the reactor DO content is typically 0 to 2 mg/L, depending on specific operational settings. As such, the dissolved oxygen contained within the sludge blanket will be consumed within a few, typically less than 5, minutes if oxygen is present at the start of Settle (S) phase 16. If designed for nutrient removal, the oxidized nitrogen compounds including nitrates (NO3) and nitrites (NO2) will be low (<3-5 mg/L) at the start of the Settle phase 16. Without DO and little NO3 and NO2, the sludge blanket within the Settle phase 16 will approach anaerobic conditions within about 10 to 15 minutes after the start. The oxidation reduction potential (ORP) will be less than −200 millivolts (mV) and anaerobic fermentation begins and exists throughout the remainder of the Settle 16, Decant 18 and Idle 20 phases. If a system is not designed for nutrient removal, higher levels of NO3 and NO2 may exist and the sludge would be considered anoxic where free DO is absent but bound oxygen is available to the bacteria via the NO3 and NO2 molecules. The anoxic ORP is typically between zero and −100 mV, but decreases (improves) as denitrifying bacteria reduce the NO3 and NO2 concentrations and form molecular nitrogen (N2). Without a soluble organic carbon substrate that is typically available in the influent feed, the denitrification process is slowed in the Settle 16, Decant 18 and Idle 20 phases and the total time available for anaerobic conditioning is reduced.

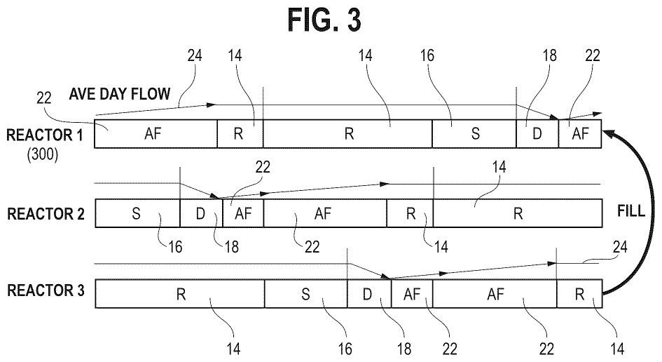

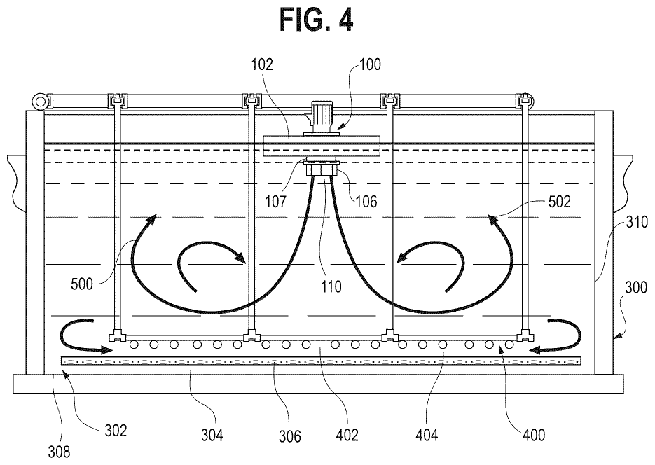

The present invention recognizes that introducing organic substrate to the bottom of the settled sludge blanket (FIG. 4) can selectively promote the growth and development of heavier biological solids that possess a higher density. Selective feeding in this manner results in a higher substrate concentration gradient and longer exposure to the substrate for the preferred, denser sludge. Conversely, the bacteria present in the lighter sludge near the top of the blanket are at a disadvantage as the substrate concentrations will be significantly lower in this region of the reactor. This control of the substrate availability will selectively reduce the development of lighter, flocculant sludge. FIG. 3 illustrates a key embodiment and goal of the present invention. When the control system identifies that the LWL 24 has been reached during the Decant phase 18, it terminates Decant 18 and closes the effluent valve. Instead of proceeding to an Idle phase 20 as shown in FIGS. 2 and 3, the reactor's influent valve is opened while closing the companion reactors' influent valve. This effectively creates an Anaerobic Feed (AF) phase 22 at the end of the cycle in lieu of a static Idle phase 20 and delivers substrate to the reactor bottom where the denser biological sludge has settled. The influent volume received during the Anaerobic Feed phase 22 will increase the water level in the reactor without significantly expanding the sludge blanket. The resulting substrate delivered to the reactor will be isolated to the bottom portion of the reactor and the high F/M is available only to the denser sludge. By directing influent substrate to the Anaerobic Feed phase 22, it also terminates influent feed to the companion reactor that is in React Fill 12, thereby reducing the substrate availability to the flocculant sludge which could otherwise thrive under the aerobic React Fill 12 phase. This invention optimizes the desired feast and famine conditions and effectively selects for denser sludge and away from the lighter flocculant sludge development.

As indicated, FIG. 3 illustrates a preferred cycle structure of the present invention, where influent is introduced only during a non-aerated, non-mixed phase. In the example, when Reactor 1 decants the treated effluent to the low water level 24, it's influent valve opens while Reactor 3's influent valve closes placing it into a React phase 14 which its reactor is aerated, but not fed. As previously described, the actual time required for the Decant phase 18 will vary based on the prevailing flow conditions. As such, the Anaerobic Feed phase 22 time available at the end of the cycle may not be sufficient to develop the proper substrate to biomass relationship and additional time is necessary. In the present invention, the Anaerobic Feed phase 22 can be extended into the beginning of the treatment cycle by replacing part or all of the previous Mix Fill 10 phase as illustrated in FIG. 3. In some instances, it may be desirable to mix the reactor contents at the end of the Anaerobic Feed phase 22 prior to aeration by implementing a Mix Fill phase 10 to further reduce the substrate level prior to aerating the reactor via the React phase 14. In cases where the waste load to the plant is exceptionally high and requires more aeration, it may be necessary to aerate the reactor before the end of the scheduled filling period. To address this situation, a React Fill phase 12 may be inserted prior to the unfed React phase 14 to avoid excessive anaerobic feed conditions. The control system will attempt to limit the aerated feed 22 (React Fill 12) conditions when possible in order to control the growth of the lighter, flocculant sludge.

Physical selection methods are necessary to retain dense bulk solids preferentially over lighter flocculant solids. Physical selection exploits the low settling velocities of poorly flocculated activated sludge and filamentous bacteria by capturing and removing these solids during the onset of a sedimentation step. Conversely, the denser biological solids which have faster settling characteristics are retained in the system. Various techniques are used to segregate high and low density biological material through gravimetric means including devices such as hydrocyclones, inclined plate settlers, phase separators and elevated solids wasting manifolds.

FIG. 4 shows a typical floating downflow mixer assembly 100 and its associated float 102 in a typical reactor basin 300. Also shown is a typical influent distribution system 302 which may include pipes 304 and apertures 306 used to deliver substrate to the system. Also shown is a typical oxygenation system 400 that may also include pipes 402 and apertures 404.

Also shown in FIG. 4 is the typical toroidal flow 500 generated by mixer 100 in tank 300 during operation. As shown, the mixing pattern during operation, the mixer volute tube and associated exit 106 directs the jet 500 toward the bottom (floor) 308 of the reactor 300 and subsequently creates a flow vector 500 toward the reactor 300 wall 310. Upon impacting the wall, the flow 500 is then directed back towards mixer 100 to be remixed and recirculated 502.

As indicated, the present invention preferably uses the flow pattern created by a high-speed, axial-flow, direct-drive mixer to select light solids from denser biomass. The floating, direct-drive mixer (DDM) 100 (FIG. 4) generates a high velocity jet discharge 500 at around 12 to 18 feet per second using a relatively small, axial flow impeller. When introduced to a larger bulk liquid, the high velocity jet effectively entrains the bulk liquid into the direction of flow. The preferred DDM 100 orients a turbulent jet discharge in a vertically downward flow towards the floor 308 of the vessel. For a distance equivalent to approximately 10 to 100 impeller diameters, the entrained volume grows and the total generated flow is many times greater than the actual pumped flow. The resulting entrained flow reflects off the vessel's floor at a distance less than 100 impeller diameters and is redirected horizontally towards a boundary condition such as a vertical wall 310 or the opposing flow from another mixer. Upon reaching the boundary condition, the flow is redirected vertically towards the vessel's surface 502. The water surface represents another boundary and redirects the flow horizontally and away from the vertical walls. With the mixer 100 positioned in the center of the basin, generated flow is directed towards the mixer's intake 107 which is adjacent to the high velocity impeller. The water is then recirculated within the basin to achieve complete suspension of both dense and lighter biological solids. Due to flow entrainment, only about 3 percent of the mixed reactor flows through the high speed impeller. The remaining 97 percent of the hydraulic circulation occurs outside the impeller and is at a substantially lower velocity to help reduce floc shearing.

The preferred floating, down flow mixer 100 was first described by Aqua-Aerobic Systems in U.S. Pat. No. 4,422,771 and has proven to be one of the most efficient mixing devices for biological solids suspension, particularly in activated sludge. A key component to the DDM's efficient mixing is the toroidal flow path 500 that is created (see FIG. 4). The DDM creates a uniform profile of suspended solids from the surface to the floor 308, with the sludge movement near the surface directed towards the mixer 100 in a 360-degree direction. When the DDM mixer 100 is turned off, the recirculation energy remains in the reactor for several (1 to 3) minutes as the velocities gradually diminish. When this occurs, the heavier solids will settle first whereas the lighter, less-dense material will take longer to settle.

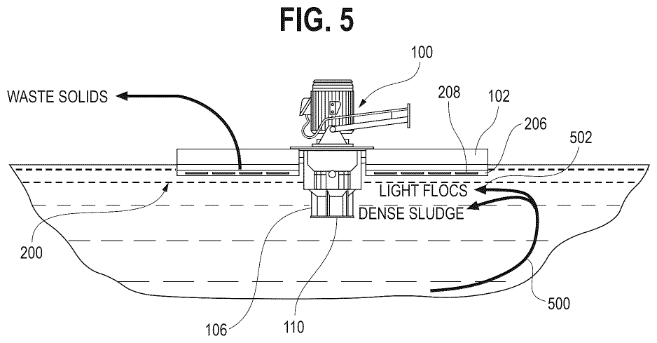

FIG. 5 shows a representation of the approach of a preferred embodiment of the present invention to selectively remove light flocculant sludge from a reactor 300 by reducing the mixing energy. The present invention includes a floating sludge collection manifold assembly 200 that is located in proximity to the mixer 100 and preferentially six to twenty-four inches below the water surface (part shown in FIG. 5). The sludge collecting manifold assembly 200 can be affixed to the mixer's float 102, or supported by an independent floatation device. Removal of solids can be accomplished by gravity using valves or the material can be pumped from the system.

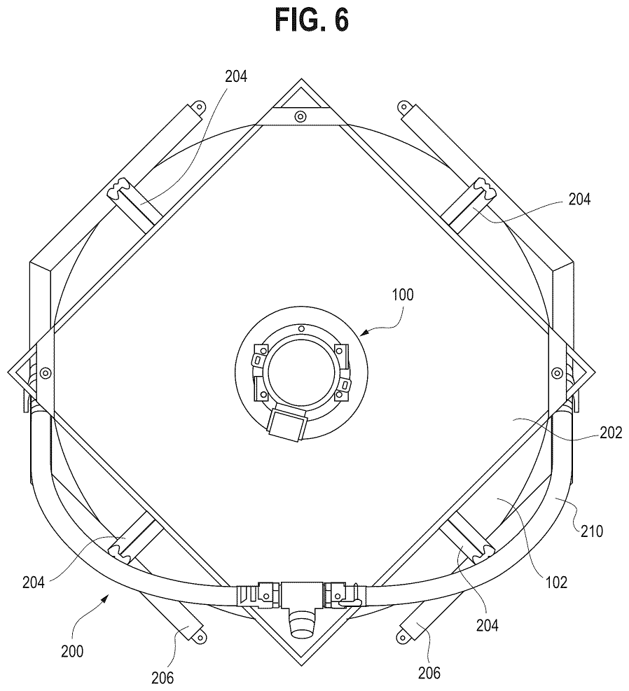

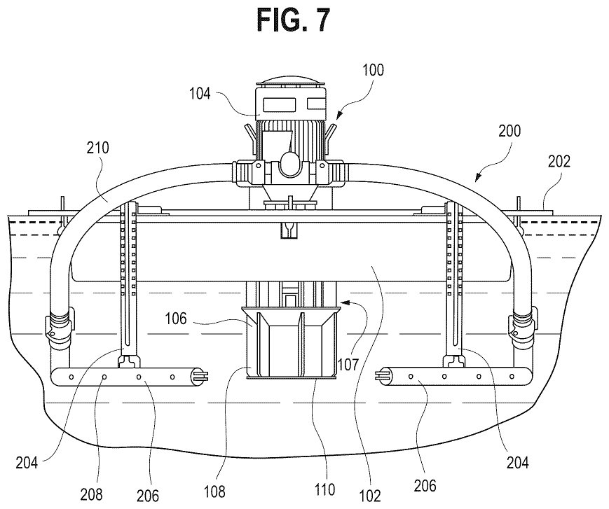

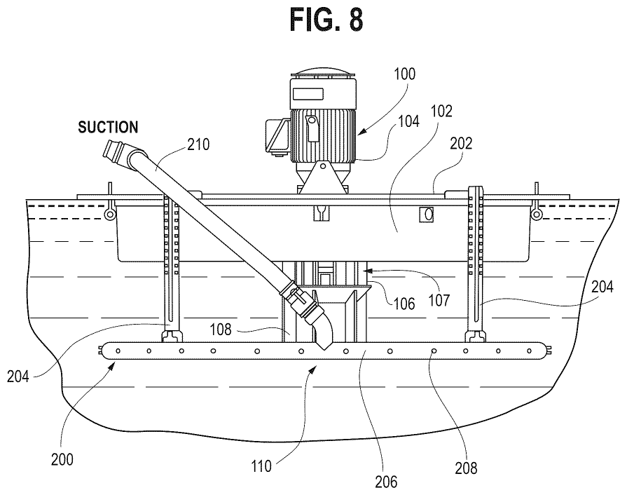

A preferred sludge collecting manifold assembly 200 of the present invention is show in FIGS. 6-8. Included is a typical downflow mixer assembly 100 having an annular float 102 which supports the mixer on the surface of the fluid to be mixed. Because of float 102, mixer assembly 100 moves up or down depending upon the water level in the reactor 300.

The mixer 100 includes a drive motor 104 mounted to float 102. A discharge volute 106 extends downward from motor 104. The upper end includes an intake 107. The lower end 108 of discharge volute 106 encases a propeller (not shown) and terminates in a discharge end 110.

In operation, because of the location of the propeller, the fluid to be mixed enters the intake 107 and is discharged out of the discharge end 110 to effectuate mixing in the tank or basin. The foregoing describes a typical downflow mixer 100 that may be used with or as part of the present invention.

The preferred sludge collecting manifold assembly 200 of the present invention may be seen in FIGS. 6-8. In addition to a typical downflow mixer 100, there is a mixer assembly frame 202, shown as square in the FIG. 6. It will be understood by those of skill in the art that assembly frame 202 may take other shapes. Assembly frame 202 may be secured to the top of float 102.

Attached to and projecting downward from mixer assembly frame 202 are four manifold support brackets 204. Attached to the lower end of the manifold support brackets 204, preferably and typically around the circumference of float 102 are solids manifolds 206. In a preferred embodiment, solids manifolds 206 are tubular members having apertures 208.

In fluid communication with the solids manifolds 206 are solid waste or suction hoses 210. When operating in a manner discussed herein, suction is applied to suction hoses 210 and certain types of desired solids are drawn through holes 208 into solids manifolds 206 and removed via the suction hoses 210.

This removes the lighter solids while permitting denser biological solids to settle to the bottom of the reactor. The removal of the less dense flocculant sludge with the sludge collecting manifold assembly shifts the biomass density characteristics toward heavier sludge resulting in its densification. It also improves the treatment capacity of the reactor.

The above description is not intended to limit the meaning of the words used in or the scope of the following claims that define the invention. Rather, it is contemplated that future modifications in structure, function or result will exist that are not substantial changes and that all such insubstantial changes in what is claimed are intended to be covered by the claims. Thus, while preferred embodiments of the present inventions have been illustrated and described, it will be understood that changes and modifications can be made without departing from the claimed invention. In addition, although the term “claimed invention” or “present invention” is sometimes used herein in the singular, it will be understood that there are a plurality of inventions as described and claimed.

Various features of the present inventions are set forth in the following claims.

What is claimed is:

1. A floating sludge collection manifold in conjunction with a floating downflow mixer assembly for use in densifying sludge in a tank or a reactor, comprising:
a downflow mixer assembly mounted to an annular float, the mixer assembly including a downwardly projecting discharge volute, the upper end of which includes a fluid intake and the lower end of which includes a propeller and an exit;
a mixer assembly frame attached to an upper side of the annular float;
a plurality of manifold support brackets having an upper end attached to the mixer assembly frame and a lower end projecting downward;
solids manifolds attached to the lower end of the manifold support brackets around the circumference of the annular float, the solids manifold including a plurality of apertures;
a plurality of suction hoses attached to and in fluid communication with the solids manifolds; and
a source of suction in communication with the suction hoses wherein suction is applied to the suction hoses to remove less dense flocculant sludge through the solids manifolds, the suction hoses and out of the reactor.

2. The floating sludge collection manifold of claim 1 wherein the solids manifolds are molded into the float structure.

3. A method for the treatment of wastewater and the densification of sludge in a sequencing batch reactor, including the steps of:
feeding influent substrate into a reactor and in contact with sludge particles containing microorganisms;
providing oxygen to the sludge particles;
mixing the reactor contents to distribute the liquid and sludge substrate materials;
permitting the heavier sludge to settle to a lower portion of the reactor;
decanting the upper portion of the fluid for discharge; and
comprising the further steps of:
a) conducting a first anaerobic feed where influent substrate contacts settled sludge particulates;
b) conducting a second anaerobically mixed phase to further reduce substrate prior to the onset of aeration;
c) conducting a third aerated reaction phase where oxygen is delivered to the sludge particles in a fluidized state;
d) conducting a fourth phase where denser sludge particles settle under quiescent conditions creating an upper zone of treated water which is decanted and discharged without introduction of influent substrate;
e) conducting a fifth phase where the clarified and treated water is decant and discharged as treated effluent without introduction of influent substrate;
f) conducting a sixth phase where a second anaerobic feed step delivers influent substrate to settled sludge particles; and,
e) removing the slow settling sludge particles from the reactor during the third aerated reaction phase using a sludge collecting manifold assembly.
